(19) United States
(12) Patent Application Publication
(10) Pub. No.: US 2009/0046994 A1
(43) Pub. Date: Feb. 19, 2009

(54) DIGITAL TELEVISION BROADCAST RECORDING AND REPRODUCTION APPARATUS AND REPRODUCTION METHOD THEREOF

(75) Inventors: Yasuhiro TAKESUE, Osaka (JP); Takaharu MOROHASHI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/169,010

(22) Filed: Jul. 8, 2008

(30) Foreign Application Priority Data
Jul. 12, 2007 (JP) 2007-183744

(51) Int. Cl. H04N 7/26

(52) U.S. Cl. 386/112; 386/E05.003

(57) ABSTRACT

The digital television broadcast recording and reproduction apparatus includes: a control unit which manages selection of either normal reproduction or digest reproduction; a decoding unit which, in the normal reproduction, generates decoded data of all pictures and their Presentation Time Stamps (PTSs), and in the digest reproduction, generates decoded data of some of the pictures and their PTSs; a catch-up detecting unit which calculates, in the digest reproduction, a difference value between one of the PTSs and a broadcast time, calculates a catch-up time at which the digest reproduction catches up with the current broadcast, sends, in the case of judging that a PTS of a next picture will overtake the current broadcast, a signal to the decoding unit indicating the judgment, and sends a catch-up signal to the control unit when the catch-up time matches the broadcast time. The control unit starts the normal reproduction upon reception of the catch-up signal.

### BACKGROUND OF THE INVENTION

(1) Field of the Invention

The present invention relates to a recording and reproduction apparatus that simultaneously records digital television signals in a recording medium and performs chasing reproduction, and to a reproduction method thereof.

(2) Description of the Related Art

Digital television broadcast recording and reproduction apparatuses have been developed for recording digital television broadcast in a medium such as a Hard Disk Drive (HDD), an SD memory card (Secure Digital Memory Card), and a DVD. This type of digital television broadcast recording and reproduction apparatuses record currently broadcasted streams in a medium, and reproduce the recorded contents later on, i.e. chasing reproduction (also called “time shift reproduction”).

With a recording medium with which reading and writing can be simultaneously carried out, the chasing reproduction allows recording of the currently broadcasted broadcast stream in the recording medium, simultaneously with reproduction of the broadcast stream recoded a predetermined time ago. In addition, when the broadcast stream is reproduced from the recording medium, a change in the reproduction speed allows the broadcast stream to catch up with the current broadcast. This reproduction method is called catch-up reproduction. Catch-up reproduction includes fast-forward reproduction, digest reproduction and others.

In the catch-up reproduction, the reproduction mode for the broadcast stream is switched to real-time reproduction (hereinafter referred to as “normal reproduction”) when the reproduction time of the broadcast stream catches up with the current broadcast time. According to Patent Reference 1, in the catch-up reproduction, a difference value between the reproduction time of a broadcast stream and the current broadcast time is calculated, and when the difference value reaches zero, it is judged that the reproduction time has caught up with the current broadcast time, and thus the reproduction mode is switched to the normal reproduction.

FIG. 1 is a diagram showing a functional configuration for describing the catch-up reproduction function of a digital television broadcast recording and reproduction apparatus of the prior art. The digital television broadcast recording and reproduction apparatus in the figure includes a tuner 2201, a HDD (Hard Disk Drive) 2202, a decoding unit 2203, an output unit 2204, a broadcast time obtaining unit 2205, a reproduction time obtaining unit 2206, a control unit 2207, and a reproduction data processing unit 2208. The tuner 2201 obtains a TS (Transport Stream) of a broadcast stream.

The HDD 2202 is a recording medium to which the TS obtained by the tuner 2201 can be written, while another TS in the HDD 2002 is read out to the decoding unit 2203.

The decoding unit 2203 decodes the TS read from the HDD 2202 via the reproduction data processing unit 2208.

The output unit 2204 displays a video decoded by the decoding unit 2203.

The broadcast time obtaining unit 2205 obtains, from the TS acquired from the tuner 2201, time information of a currently broadcasted stream (hereinafter referred to as “broadcast time information”).

The reproduction time obtaining unit 2206 obtains, from the TS read from the HDD 2202, time information of a currently reproduced broadcast stream (hereinafter referred to as “reproduction time information”).

The control unit 2207 controls the catch-up reproduction by sending, to the reproduction data processing unit 2208, a reproduction speed control signal based on the broadcast time information obtained from the broadcast time obtaining unit 2205 and the reproduction time information obtained from the reproduction time obtaining unit 2206.

The reproduction data processing unit 2208 selects TS data which is appropriate to be provided to the decoding unit 2203, based on the reproduction speed control signal received from the control unit 2207. More specifically, the reproduction data processing unit 2208 selects, based on the reproduction speed control signal received, whether to provide catch-up reproduction data or normal reproduction data to the decoding unit 2203.

Next, with reference to a flow chart of FIG. 2, operations for catch-up reproduction of the prior art shall be described. The figure schematically shows processing operations from when the reproduction time of a broadcast stream catches up with the current broadcast time, up to when the reproduction mode is switched from the catch-up reproduction to the normal reproduction.

First, the catch-up reproduction starts in response to an instruction from a viewer (S2301).

Next, the control unit 2207 obtains broadcast time information of a currently broadcasted stream from the broadcast time obtaining unit 2205, and reproduction time information of a currently reproduced stream from the reproduction time obtaining unit 2206 (S2302).

Then, the control unit 2207 calculates a difference value in time between the obtained broadcast time information and reproduction time information, and when the difference value is zero, sends a reproduction speed control signal to the reproduction data processing unit 2208, instructing to switch from the catch-up reproduction to the normal reproduction (Yes in S2303). When the difference value is not zero, the processing returns to the obtainment of updated broadcast time information and updated reproduction time information (No in S2303).

Lastly, upon reception of the instruction to switch from the catch-up reproduction to the normal reproduction, the reproduction data processing unit 2208 reads, from the HDD 2202, TS data for the normal reproduction, and switches the reproduction mode from the catch-up reproduction to the normal reproduction (52304).

[Patent Reference 1] Japanese Unexamined Patent Application Publication No. 2001-119671

However, the above described digital television broadcast recording and reproduction apparatus of the prior art entails two problems described below, for a transition in switching from the catch-up reproduction to the normal reproduction.

At first, with reference to FIG. 3, a first problem to be solved by the present invention shall be described. FIG. 3 is a graph showing a transition in switching from the catch-up reproduction to the normal reproduction. The horizontal axis represents real time, and the vertical axis represents time indicated by PTS (Presentation Time Stamp) which is reproduction time information.

The figure shows a case of performing, as an example of catch-up reproduction, catch-up reproduction by outputting IDR (Instantaneous Decording Refresh) pictures at regular intervals, that is, digest reproduction. The digest reproduction here refers to reproduction performed by outputting only IDR pictures of a video in the MPEG-4 AVC format, for example. According to the operation regulations of the one-segment broadcasting scheme currently in use, the IDR pictures are inserted at a cycle of two to five seconds. Therefore, with the catch-up reproduction for consecutively reproducing IDR pictures, the video is displayed with reproduction time skipped at the intervals of two to five seconds.

At first, during a time period Y1, digest reproduction is performed. In the case of digest reproduction, the process for detecting that the time indicated by a PTS of a broadcast stream has caught up with the current broadcast time (process shown in the flow chart of FIG. 2) can be performed only at the IDR picture intervals (two to five seconds), which are the timings at which PTS's of broadcast streams can be obtained. FIG. 3 shows an example of detecting that the reproduction time has caught up with the current broadcast time, through a virtual IDR picture X3 whose PTS in digest reproduction has overtaken the current broadcast time, and then switching the reproduction mode to the normal reproduction. However, with the X3, since the current broadcast time is already overtaken, an unnatural time period Y2 arises during which the video temporarily freezes, resulting in a waiting time Y0 before the digest reproduction is switched to the normal reproduction, including a time period of displaying a frozen IDR picture X2.

Next, a second problem to be solved by the present invention shall be described. The catch-up detection may result in false detection when a PTS of a broadcast stream cannot be correctly obtained due to, for example, a reception trouble or the like, or a stream temporarily dropped out. This problem shall be described with reference to FIG. 4. The figure shows a diagram describing the second problem of the prior art, and similarly to FIG. 3, the horizontal axis represents real time, and the vertical axis represents time indicated by PTS which is reproduction time information. In this case, PTS's of pictures currently being reproduced by the catch-up reproduction are fragmentarily corrupted during a time period Y5, and thus the time indicated by the PTS's of the streams become dramatically shifted from the current broadcast time, disabling the catch-up detection (the judgment at S2303 in the flow chart in FIG. 2 does not become Yes), resulting in a waiting time equal to or longer than the time period Y5.

### SUMMARY OF THE INVENTION

The present invention has been conceived in view of the problems described above, and has an object to provide a digital television broadcast recording and reproduction apparatus for eliminating the unnaturalness and abnormality in reproducing broadcast streams, at the time of switching from the catch-up reproduction to the normal reproduction, and for minimizing a time lag which arises at the switching process.

In order to solve the above described problems, the digital television broadcast recording and reproduction apparatus according to the present invention is a digital television broadcast recording and reproduction apparatus which has a readable and writable recording medium, and records and reproduces information of a digital television signal received, the apparatus comprising: a control unit configured to receive an instruction from a user concerning either normal reproduction or digest reproduction, and manage the received instruction, the normal reproduction being for real-time reproduction of the digital television signal, and the digest reproduction being for partial reproduction of the digital television signal recorded in the recording medium; a decoding unit configured to (i) in the normal reproduction, decode all pictures of coded data included in the digital television signal, and output the decoded data and time stamps each of which is associated with corresponding one of the decoded pictures, and (ii) in the digest reproduction, decode the pictures of the coded data at regular intervals, and output the decoded data and time stamps each of which is associated with corresponding one of the decoded pictures; and a catch-up detecting unit configured to perform a digest catch-up detection process of (i) calculating, for each of the time stamps outputted in the digest reproduction, a difference value between a time indicated by the time stamp and a time of a current broadcast, (ii) calculating, based on the calculated difference value, a catch-up time at which the digest reproduction catches up with the current broadcast, (iii) sending a digest reproduction pre-ending signal to the decoding unit when judging, based on the calculated catch-up time, that a time indicated by a time stamp of a next picture overtakes the catch-up time, and (iv) sending a catch-up signal to the control unit when the catch-up time matches the time of the current broadcast, wherein the decoding unit is configured to end the decoding for the digest reproduction when the digest reproduction pre-ending signal is received from the catch-up detecting unit during the digest reproduction, and the control unit is configured to, when the catch-up signal is received from the catch-up detecting unit, cause the decoding unit to start the normal reproduction by notifying the decoding unit that the digest reproduction is to be switched to the normal reproduction.

As a result, when the digest reproduction is selected and executed as chasing reproduction, an unnatural time period does not occur during which the reproduction pauses since the digest reproduction jumps the current broadcast, and thus the time lag for switching from the digest reproduction to the normal reproduction is minimized.

Here, it may be that the digital television broadcast recording and reproduction apparatus further comprises a remaining-amount monitoring unit configured to monitor a remaining amount of the digital television signal accumulated in the recording medium, and when the remaining amount becomes zero, send a no-remaining-amount signal to the catch-up detecting unit indicating that the remaining amount has become zero, wherein the control unit is configured to receive an instruction from the user concerning fast-forward reproduction for fast-forwarding the digital television signal, and manage the received instruction, the decoding unit is configured to, in the fast-forward reproduction, decode all the pictures of the coded data included in the digital television signal, and output the decoded data and time stamps each of which is associated with corresponding one of the decoded pictures, the catch-up detecting unit is further configured to, in the fast-forward reproduction, perform a fast-forward catch-up detection process of sending the catch-up signal to the control unit when the fast-forward reproduction catches up with the current broadcast, and the catch-up detecting unit is configured to start either the fast-forward catch-up detection process or the digest catch-up detection process when the no-remaining-amount signal is received from the remaining-amount monitoring unit.

As a result, there is no need to perform the catch-up detection on a picture-by-picture basis from the beginning of the chasing reproduction. In addition, the workload for the catch-up detection is reduced and thus power consumed by the apparatus can be reduced when the remaining amount in the recording medium becomes zero, that is, by performing the catch-up detection only on the frames remaining in the buffer of the demultiplexing unit.

Furthermore, it may be that the digital television broadcast recording and reproduction apparatus further comprises: an abnormal-decoding monitoring unit configured to detect abnormal decoding performed by the decoding unit; and a remaining-amount monitoring unit configured to monitor a remaining amount of the digital television signal accumulated in the recording medium, and when the remaining amount becomes zero, send a no-remaining-amount signal to the abnormal-decoding monitoring unit indicating that the remaining amount has become zero, wherein the control unit is configured to receive an instruction from the user concerning fast-forward reproduction for fast-forwarding the digital television signal, and manage the received instruction, the decoding unit is configured to, in the fast-forward reproduction, decode all the pictures of the coded data included in the digital television signal, and output the decoded data and time stamps each of which is associated with corresponding one of the decoded pictures, the catch-up detecting unit is configured to, in the fast-forward reproduction, perform a fast-forward catch-up detection process of sending the catch-up signal to the control unit when the fast-forward reproduction catches up with the current broadcast, the abnormal-decoding monitoring unit is configured to send a catch-up stop signal to the catch-up detecting unit when the no-remaining-amount signal is received from the remaining-amount monitoring unit and the abnormal decoding is detected, and the catch-up detecting unit is configured to stop either the fast-forward catch-up detection process or the digest catch-up detection process when the catch-up stop signal is received.

As a result, false detection in the catch-up detection process can be prevented. As a result of the prevention of false detection, it is possible to prevent output data from being frozen and prevent the normal reproduction from starting at an unexpected scene. In this case, the pictures remaining in the buffer of the demultiplexing unit are discarded. Nonetheless, this is because of a fail-safe based idea that rather than making false detection by continuing the catch-up detection process with a picture judged as being abnormal in the decoding process, it is preferred to stop the catch-up detection and switch to the current broadcast.

Preferably, the control unit is configured to receive an instruction from the user concerning fast-forward reproduction for fast-forwarding the digital television signal, and manage the received instruction, the decoding unit is configured to, in the fast-forward reproduction, decode all the pictures of the coded data included in the digital television signal, and output the decoded data and time stamps each of which is associated with corresponding one of the decoded pictures, and the catch-up detecting unit (i) includes a time counter that monotonically decreases a count value as time elapses, and (ii) is configured to initialize, at a start of the fast-forward reproduction, the time counter with a difference value between a time indicated by one of the time stamps outputted in the fast-forward reproduction and the time of the current broadcast, and to send the catch-up signal to the control unit when the count value becomes zero.

As a result, the picture-by-picture based catch-up detection process is unnecessary, and thus the power consumed by the apparatus can be reduced. In addition, no false detection results from an abnormality signal occurred during the catch-up reproduction, and thus the switch to the normal reproduction can be reliably achieved.

It may further be that the digital television broadcast recording and reproduction apparatus further comprises, a reproduction time generating unit configured to (i) withhold outputting of a time stamp of a most recent picture to the catch-up detecting unit, (ii) generate a time stamp to replace the time stamp of the most recent picture based on time stamps of preceding pictures up to a picture immediately preceding the most recent picture and (iii) output the generated time stamp to the catch-up detecting unit, when a difference value between the time indicated by the time stamp of the most recent picture obtained from the decoding unit and a time indicated by the time stamp of the picture immediately preceding the most recent picture is above a predetermined threshold range.

As a result, even in a situation where a PTS of each picture was not correctly obtained, an unnecessary waiting time attributed to such a situation does not occur, and the catch-up can be detected correctly.

It is to be noted that the present invention can be embodied not only as a digital television broadcast recording and reproduction apparatus having such characteristic units as described above, but also as a mobile phone having such a digital television broadcast recording and reproduction apparatus, to have the same configuration and produce the same advantageous effects.

Further, the present invention can be embodied not only as a digital television broadcast recording and reproduction apparatus having such characteristic units, but also as a digital television broadcast recording and reproduction method having, as steps, the characteristic units of the digital television broadcast recording and reproduction apparatus, and as a program causing a computer to execute the characteristic steps of the digital television broadcast recording and reproduction method. It is apparent that such a program can be distributed via recording media such as a CD-ROM (Compact Disc-Read Only Memory) or via transmission networks such as the Internet.

The present invention makes it possible to eliminate the unnaturalness and abnormality in reproducing broadcast streams, at the time of switching from the catch-up reproduction to the normal reproduction, and thus possible to minimize a time lag which arises at the switching process.

### FURTHER INFORMATION ABOUT TECHNICAL BACKGROUND TO THIS APPLICATION

The disclosure of Japanese Patent Application No. 2007-183744 filed on Jul. 12, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a functional configuration for describing the catch-up reproduction function of a digital television broadcast recording and reproduction apparatus of the prior art;

FIG. 2 is a flow chart of operations for the catch-up reproduction performed by a digital television broadcast recording and reproduction apparatus of the prior art;

FIG. 3 is a graph describing a first problem of the prior art;

FIG. 4 is a graph describing a second problem of the prior art;

FIG. 5 is a diagram showing the functional configuration of a digital television broadcast recording and reproduction apparatus according to Embodiment 1 of the present invention;

FIG. 6 is a diagram showing a structure of TS data according to Embodiment 1 of the present invention;

FIG. 7 is a data structure diagram showing a relationship between a TS packet and a PES packet according to Embodiment 1 of the present invention;

FIG. 8 is a graph for describing STC calibration according to Embodiment 1 of the present invention;

FIG. 9 is a diagram showing a structure of PES packet data according to Embodiment 1 of the present invention;

FIG. 10 is a table showing a relationship between reproduction modes and details of decoding process according to Embodiment 1 of the present invention;

FIG. 11 is a flow chart of a catch-up detection process according to Embodiment 1 of the present invention;

FIG. 12 is a diagram showing a relationship between PTS and STC in a digest reproduction mode according to Embodiment 1 of the present invention;

FIG. 13 is a flow chart of a reproduction mode determination process according to Embodiment 1 of the present invention;

FIG. 14 is a flow chart of operations of a digital television broadcast recording and reproduction apparatus according to Embodiments 1 and 2 of the present invention;

FIG. 15 is a schematic diagram for describing the structure of a recording medium according to Embodiment 1 of the present invention;

FIG. 16 is a flow chart of a catch-up detection process according to Variation 1 of Embodiment 1 of the present invention;

FIG. 17 is a diagram showing the functional configuration of a digital television broadcast recording and reproduction apparatus according to Variation 2 of Embodiment 1 of the present invention;

FIG. 18 is a graph for describing calibration of reproduction time according to Variation 2 of Embodiment 1 of the present invention;

FIG. 19 is a flow chart of operations of a reproduction time generating unit according to Variation 2 of Embodiment 1 of the present invention;

FIG. 20 is a diagram showing the functional configuration of a digital television broadcast recording and reproduction apparatus according to Embodiment 2 of the present invention;

FIG. 21 is a flow chart of the operation procedure according to Embodiment 2 of the present invention;

FIG. 22 is a diagram showing the functional configuration of a digital television broadcast recording and reproduction apparatus according to Embodiment 3 of the present invention;

FIG. 23 is a block diagram showing the entire configuration in the case where the present invention is applied to a mobile phone as Embodiment 4 of the digital television broadcast recording and reproduction apparatus according to the present invention;

FIG. 24 is an external view of a mobile phone which is an embodiment of the digital television broadcast recording and reproduction apparatus according to the present invention; and

FIG. 25 is an external view of a digital television system having a DVD recorder, which is an embodiment of the digital television broadcast recording and reproduction apparatus according to the present invention.

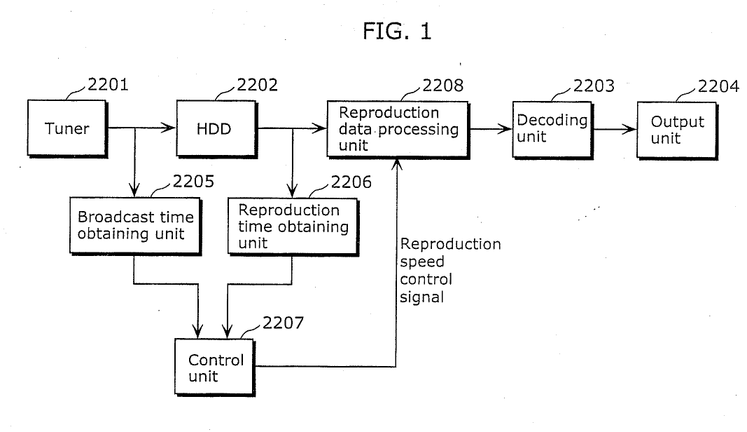

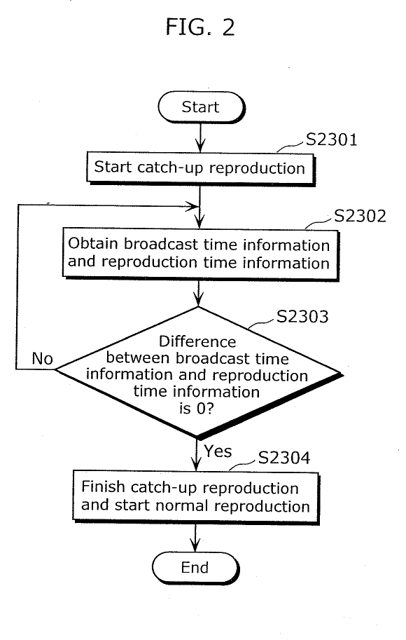

### DESCRIPTION OF THE PREFERRED EMBODIMENT(S)

### Embodiment 1

During digest reproduction, a digital television broadcast recording and reproduction apparatus according to the present Embodiment 1 predicts a catch-up time at which the digest reproduction catches up with the current broadcast; ends decoding for the digest reproduction when judging that a PTS (Presentation Time Stamp) of the next IDR (Instantaneous Decording Refresh) picture will overtake the catch-up time; and switches from the digest reproduction to the normal reproduction when the catch-up time and the current broadcast time match each other. As a result, there is no unnatural waiting time during which the video temporarily freezes because the digest reproduction jumps the current broadcast, and thus it is possible to minimize the time lag which arises at the time of switching from the digest reproduction to the normal reproduction.

Here, a single frame in a progressive image and a field in an interlace image are both called a picture.

Hereinafter, with reference to the drawings, Embodiment 1 of the present invention shall be described in detail.

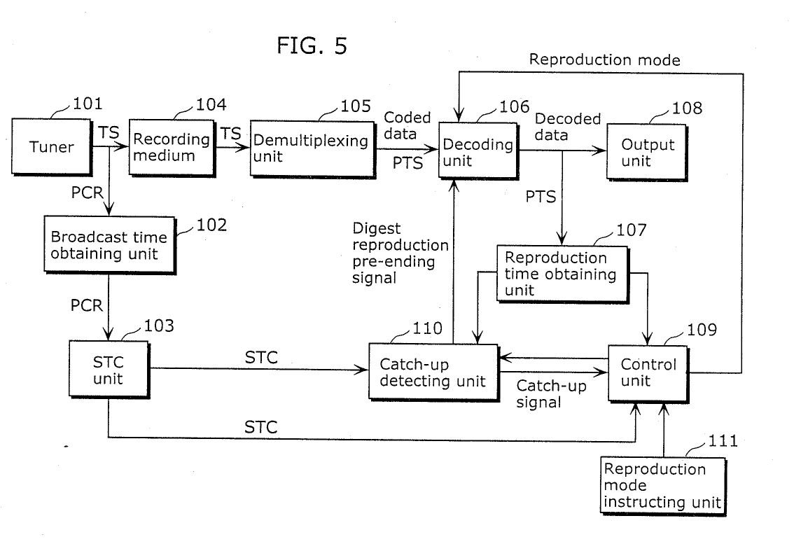

FIG. 5 is a diagram showing the functional configuration of the digital television broadcast recording and reproduction apparatus according to Embodiment 1 of the present invention. The digital television broadcast recording and reproduction apparatus in the figure includes a tuner 101, a broadcast time obtaining unit 102, an STC unit 103, a recording medium 104, a demultiplexing unit 105, a decoding unit 106, a reproduction time obtaining unit 107, an output unit 108, a control unit 109, a catch-up detecting unit 110, and a reproduction mode instructing unit 111.

The tuner 101 demodulates a digital television broadcast signal received. From the demodulated signal, the digital television broadcast recording and reproduction apparatus obtains a stream selected by a user. Then, the tuner 101 transfers a TS (Transport Stream) to the recording medium 104, and outputs a current TS time information attached to the TS (hereinafter referred to as “PCR (Program Clock Reference)”) to the broadcast time obtaining unit 102.

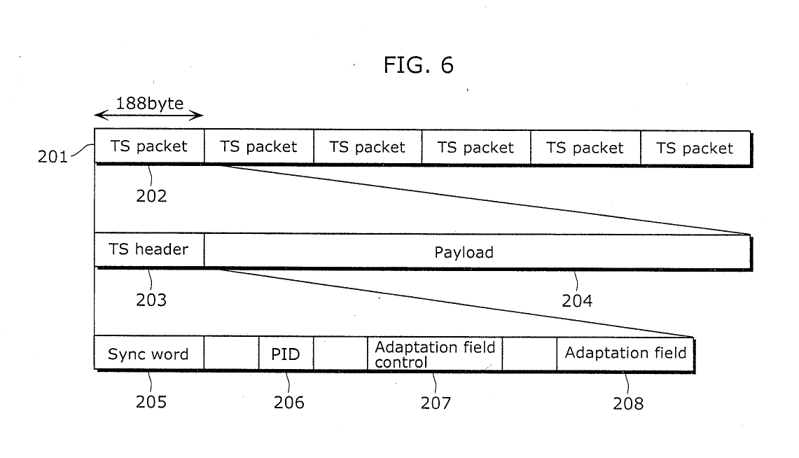

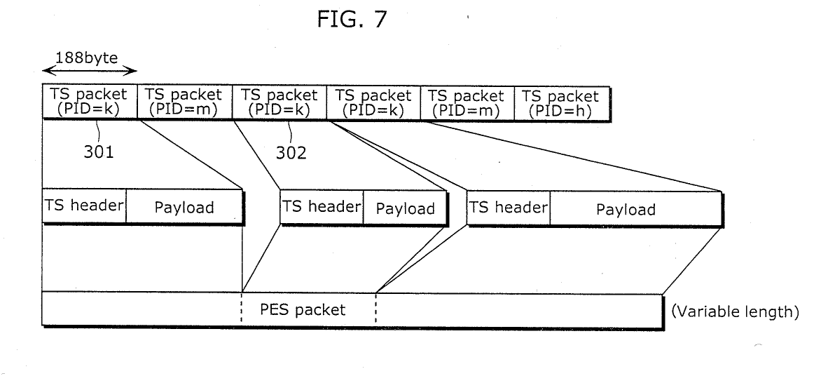

Here, with reference to FIGS. 6 and 7, the data structure of the TS shall be described. In FIG. 6, TS data 201 comprises a plurality of TS packets 202 each having a fixed length of 188 bytes. Each TS packet 202 includes a TS header 203 and a payload 204. The TS header 203 includes a sync word 205 indicating the head of the TS packet 202; a PID 206 identifying data in the TS packet 202; an adaptation field control 207 indicating whether or not the payload 204 is valid; an adaptation field 208; and other control flags.

Further, as shown in FIG. 7, a PES (Packetized Elementary Stream) packet transferred in a TS is transferred in separate packets having the same PID value (PID=k), i.e. fixed-length TS packets 301 and 302. Here, a PCR attached to the TS data 201 is transferred at every predetermined time to be consistent with the system time clock (hereinafter, referred to as “STC”) of the digital TV broadcast recording and reproduction apparatus. The PCR is distributed to an optional field in the adaptation field 208, with six bytes.

Now, the functional configuration diagram of FIG. 5 is referred to again to continue with the description.

The broadcast time obtaining unit 102 outputs, to the STC unit 103, a PCR obtained from the tuner 101.

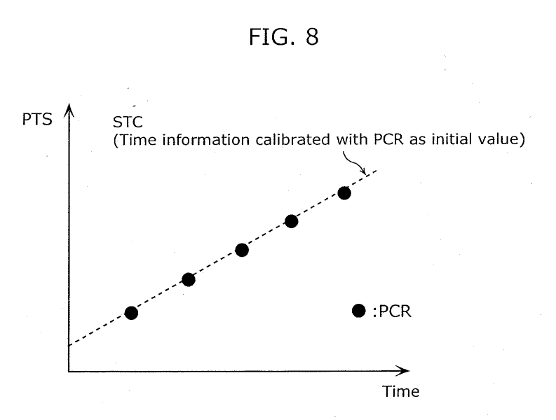

The STC unit 103 generates the STC of the digital TV broadcast recording and reproduction apparatus. With each value of PCR received at every predetermined time as an initial value, the STC is counted at 27 MHz, for example, and is calibrated based on the time information of PCR. FIG. 8 is a graph describing the STC calibration. In the figure, the horizontal axis represents real time, and the vertical axis represents time indicated by PTS which is reproduction time information. The figure shows an example of linear calibration of the STC with each value of PCR notified at every predetermined time as an initial value.

Now, the functional configuration diagram of FIG. 5 is referred to again to continue with the description.

The recording medium 104 is for recording the TS data 201, and allows simultaneous reading and writing. Examples of this medium include a semiconductor memory, a hard disk drive (HDD), an optical disk (DVD), and so on. When broadcast streams are reproduced normally, the TS data 201 passes through this medium and is not accumulated therein. The accumulation of the TS data 201 begins when the normal reproduction is paused through a user specification, and continues until the pause is cancelled through another user specification. After the pause is cancelled, the TS data 201 accumulated in the recording medium 104 is reproduced, and meanwhile, written to the recording medium 104 from the tuner 101. The reproduction of the TS data 201 accumulated in the recording medium 104, that is, the reproduction of the broadcast stream shifted by some time, is generally called chasing reproduction (also referred to as “time-shift reproduction”). During chasing reproduction, it is controlled so that the reproduction of broadcast streams catches up with the current broadcast through a trick play such as fast-forward reproduction and digest reproduction. In other words, catch-up reproduction is performed. The reproduction mode is switched from the catch-up reproduction to the normal reproduction when the reproduction of the broadcast stream catches up with the current broadcast. After it is switched to the normal reproduction, the recording medium 104 becomes empty.

The demultiplexing unit 105 has a function to extract coded data and a PTS, which is reproduction time information, from a PES header in a PES packet, and to hold them in a built-in buffer.

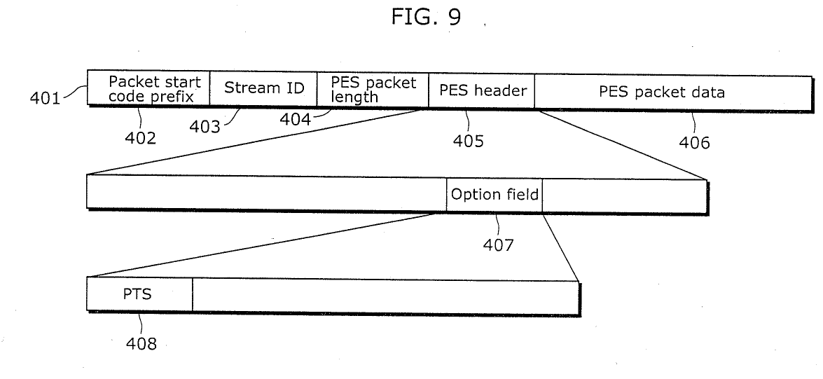

Here, with reference to FIG. 9, the data structure of a PES packet shall be described. PES data 401 includes a packet start code prefix 402 indicating the head of the PES packet; a stream ID 403 for identifying a stream included in the PES data 401; a PES packet length 404 indicating the length of the PES packet; a PES header 405; and PES packet data 406 in which stream data is stored.

Furthermore, the PES header 405 includes an option field 407, other control flags, and so on. In the option field 407, PTS 408 is stored which is reproduction time information of the stream. Further, in the PES packet data 406, coded data is stored.

Referring back to the functional configuration diagram of FIG. 5, the TS's written to the recording medium 104 are sequentially transferred to the demultiplexing unit 105 which demultiplexes the TS's, and extracts a PTS and coded data from each of the demultiplexed TS's, and writes the extracted PTS and coded data to its built-in buffer. Then, the written PTS and coded are transferred to the decoding unit 106. The built-in buffer has a capacity large enough to prevent overflows when broadcast streams are reproduced by the normal reproduction. While the chasing reproduction is performed, it is controlled so that overflows do not occur at the time of transferring the TS's from the recording medium 104 to the demultiplexing unit 105, and that the TS data 201 held in the recording medium 104 is transferred to the demultiplexing unit 105 when the buffer built in the demultiplexing unit 105 becomes empty.

In the normal reproduction mode, the decoding unit 106 decodes all the pictures of the coded data included in the digital television signal, and outputs the decoded data and time stamps associated with the decoded pictures. In the digest reproduction mode, it decodes pictures of the coded data at regular intervals, and outputs the decoded data and time stamps associated with the decoded pictures. In the present embodiment, the decoding unit 106 decodes coded data transferred from the demultiplexing unit 105. For video, this decoding process is the image decoding process in accordance with MPEG4-AVC/H.264 standards or MPEG-2/4 standards, for example, whereas for audio, it is the decoding process in accordance with AAC. The decoding unit 106 transfers, to the output unit 108, the decoded data in association with the PTS transferred from the demultiplexing unit 105, and at the same time, outputs the PTS to the reproduction time obtaining unit 107.

The decoding process of the decoding unit is performed in accordance with the reproduction mode notified by the control unit 109. Reproduction modes include three modes, i.e. the normal reproduction mode, the fast-forward reproduction mode, and the digest reproduction mode. The decoding process varies depending on the modes. The normal reproduction mode is for real-time reproduction of broadcast streams. The digest reproduction mode and the fast-forward reproduction mode are for catch-up reproduction performed during chasing reproduction.

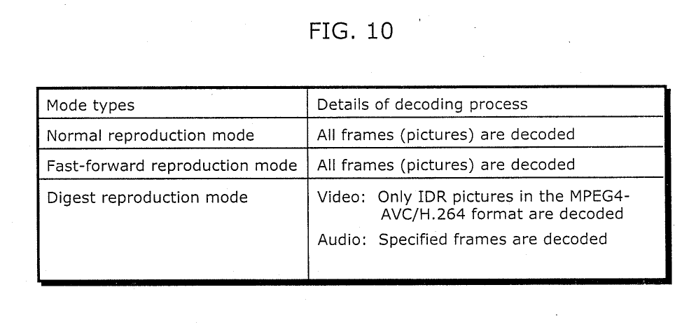

FIG. 10 shows the details of the decoding process for each mode. As FIG. 10 shows, in the case of the normal reproduction mode and the fast-forward reproduction mode, all the frames (pictures) in both video and audio are decoded. In the case of the digest reproduction mode for video, only the IDR pictures in the MPEG4-AVC/H.264 format are decoded, whereas in the case of the digest reproduction mode for audio, only specified frames are decoded.

Now, the functional configuration diagram of FIG. 5 is referred to again to continue with the description.

Management of the reproduction modes is carried out by the reproduction mode instructing unit 111, and the selected reproduction mode is notified to the decoding unit 106 via the control unit 109.

The decoding process is performed at different timings depending on the reproduction modes. In the case of the normal reproduction mode, the decoding process for video is performed every 66 ms, given that 15 frames are decoded per second, or every 33 ms, given that 30 frames are decoded per second, whereas the decoding process for audio is performed every 42 ms at Advanced Audio Coding (AAC) 24 kHz, or every 22 ms at AAC 48 kHz. In the case of the fast-forward reproduction mode for reproduction at N times the normal speed, the decoding process for video is performed every 66/N ms, given that 15 frames are decoded per second, or every 33/N ms, given that 30 frames are decoded per second, whereas the decoding process for audio is performed every 42/N ms at AAC 24 kHz, or every 22/N ms at AAC 48 kHz. For example, when N is 2 (fast-forward reproduction at twice the normal speed), the decoding process for video is performed every 33 ms, given that 15 frames are decoded per second, or every 16 ms, given that 30 frames are decoded per second, whereas the decoding process for audio is performed every 21 ms at AAC 24 kHz, or every 11 ms at AAC 48 kHz.

In the case of the fast-forward reproduction mode, when audio is to be outputted, audio speed conversion is carried out before decoded data is transferred to the output unit 108. There is a PICOLA method as an example of audio speed conversion technique. In the case of the digest reproduction mode for video, only IDR pictures are decoded, and the decoded data is transferred to the output unit 108 at regular time intervals, whereas in the case of the digest reproduction mode for audio, data at regular intervals is decoded, and the decoded data is transferred to the output unit 108 at regular time intervals.

The reproduction mode instructing unit 111 determines a reproduction mode in accordance with a user specification, and notifies the control unit 109 of the determined reproduction mode. As mentioned above, the reproduction modes include three modes, i.e. the normal reproduction mode, the digest reproduction mode, and the fast-forward reproduction mode.

The output unit 108 outputs decoded data (i.e. images in the case of video, and sound in the case of audio) transferred from the decoding unit 106.

The reproduction time obtaining unit 107 holds PTS's notified by the decoding unit 106.

The control unit 109 receives and manages instructions from a user concerning either the normal reproduction for real-time reproduction of digital television signals or the digest reproduction partial reproduction of the digital television signals. In the present embodiment, the control unit 109 performs control in accordance with each of the aforementioned three reproduction modes.

The control unit 109 calculates a difference value between a PTS obtained from the reproduction time obtaining unit 107 and the STC obtained from the STC unit 103, and when the calculated difference value is outside a threshold range, instructs the decoding unit 106 to change the timing at which the decoding process is performed. For example, when the difference value between the PTS and the STC is above the threshold range, the PTS of the broadcast stream is judged as being ahead of the STC, and thus the control unit 109 controls the decoding unit 106 so that the decoding process is stopped for the difference value between the PTS and the STC. Further, when the difference value between a PTS and the STC is below the threshold range, the PTS of the broadcast stream is judged as being behind the STC, and thus the control unit 109 controls the decoding unit 106 so that the pictures at regular intervals are decoded, for example. In this way, the control unit 109 performs control so that the difference value between the PTS and the STC is always within the threshold range.

In addition, in the fast-forward reproduction mode or the digest reproduction mode, the control unit 109 notifies the decoding unit 106 of the selected mode, and causes it to start the above described decoding process, and at the same time, also notifies the catch-up detecting unit 110 of the selected mode, and causes it to start a catch-up detection process which shall be described later.

When the control unit receives an instruction for the digest reproduction, the catch-up detecting unit 110 (i) calculates a difference value between a time indicated by one of the time stamps outputted in the digest reproduction and a time of a current broadcast, (ii) calculates, based on the calculated difference value, a catch-up time at which the digest reproduction catches up with the current broadcast, (iii) sends a digest reproduction pre-ending signal to the decoding unit when judging, based on the calculated catch-up time, that a time indicated by a time stamp of the next picture overtakes the catch-up time, and (iv) sends a catch-up signal to the control unit when the catch-up time matches the time of the current broadcast. In the present embodiment, in the catch-up reproduction (the fast-forward reproduction mode, the digest reproduction mode) performed in accordance with the reproduction mode notified by the control unit 109, the catch-up detecting unit 110 judges whether or not the PTS of the broadcast stream has caught up with the STC (hereinafter referred to as “catch-up detection process”). The catch-up detection process is performed differently between the fast-forward reproduction mode and the digest reproduction mode.

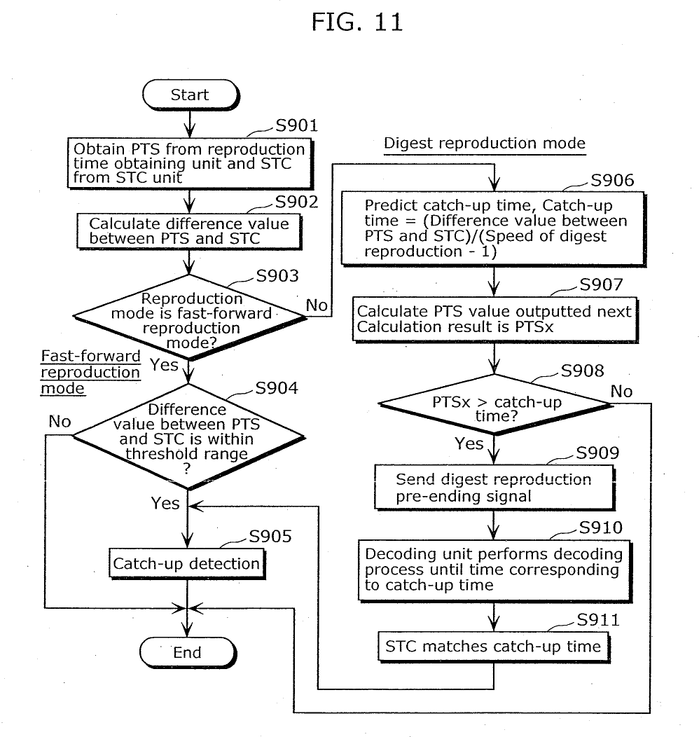

Hereinafter, the catch-up detection process shall be described. FIG. 11 is a flow chart of operations performed by the catch-up detecting unit. At first, the catch-up detecting unit 110 obtains a PTS from the reproduction time obtaining unit 107 and the STC from the STC unit 103 (S901). Next, the catch-up detecting unit 110 calculates a difference value between the time indicated by the obtained PTS and the time indicated by the STC (S902). When the reproduction mode notified by the reproduction mode instructing unit 111 is the fast-forward reproduction mode (Yes in S903), the catch-up detecting unit 110 judges whether or not the difference value between the time indicated by the PTS and the time indicated by the STC is within a threshold range (S904). When the difference value is within the threshold range (Yes in S904), the PTS of the broadcast stream is judged to have caught up with the STC, and thus the catch-up detecting unit 110 sends a catch-up signal to the control unit 109 (S905). When the difference value is outside the threshold range (No in S904), it is judged that the PTS of the broadcast stream has not caught up with the STC, and thus the process ends.

When the reproduction mode is not the fast-forward reproduction mode (No in S903), that is, when the reproduction mode is the digest reproduction mode, the catch-up detecting unit 110 predicts the time at which the PTS catches up with the STC (S906). This predicted time is called a catch-up time.

Here, the catch-up time and a calculation method thereof shall be described.

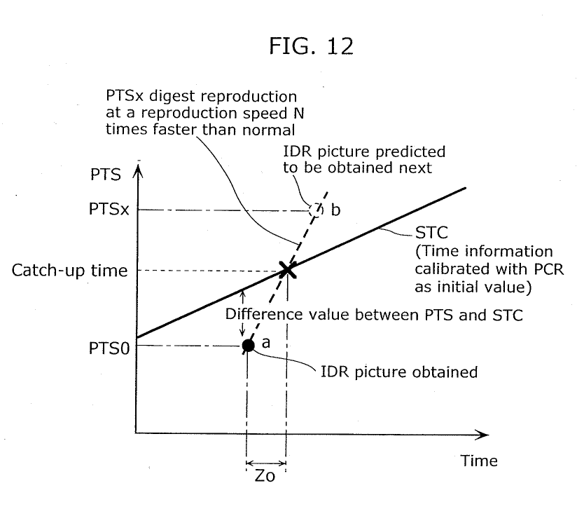

FIG. 12 is a graph showing a relationship between the digest reproduction (in which only IDR pictures are reproduced) and the current broadcast. The horizontal axis represents real time, and the vertical axis represents time indicated by PTS which is reproduction time information. The solid line represents the STC calibrated with each of PCR's as an initial value. That is, it represents the current broadcast. Further, a point a represents an IDR picture obtained from the reproduction time obtaining unit 107. The catch-up time can be calculated by: Difference value between PTS and STC/(N−1), given that the reproduction speed for the digest reproduction is N times the normal speed. That is to say, in FIG. 12, calculating a point of intersection of the dotted line connecting the discretely obtained IDR pictures and the solid line representing the STC provides the time at which the PTS catches up with the STC (point shown as x in the figure).

Returning to the flow chart of FIG. 11, the description shall continue with reference to FIG. 12.

When the digest reproduction is in process, the catch-up detecting unit 110 calculates a reproduction time PTSx predicted to be obtained next (S907). In FIG. 12, the time information indicated by a point b is PTSx. The PTSx is calculated by adding a difference value between PTS's of two adjacent IDR pictures to a reproduction time PTS0 of the most recently obtained IDR picture a. For example, in the case where IDR pictures in video are sent out every two seconds, it can be understood that there is a two-second interval between one PTS and another, and thus PTSx=PTS0+2 seconds.

Next, the catch-up detecting unit 110 compares the calculated PTSx and the catch-up time (S908).

When PTSx>the catch-up time (Yes in S908), judging that the reproduction time will overtake the current broadcast time by the time the next PTS is obtained, the catch-up detecting unit 110 sends the digest reproduction pre-ending signal to the decoding unit 106 (S909).

Together with the digest reproduction pre-ending signal, the decoding unit 106 also receives the catch-up time as information. Then, based on the received catch-up time and the PTS notified by the demultiplexing unit 105, the decoding unit 106 decodes pictures until it decodes a picture associated with the catch-up time (S910). In other words, for video, the decoding unit 106 stops the decoding process performed only on the IDR pictures, and starts decoding all the pictures until it decodes the picture associated with the catch-up time. For audio, it stops decoding frames at regular intervals, and starts decoding all the pictures until it decodes the picture associated with the catch-up time. Here; the decoded data up to that of the frame (picture) associated with the catch-up time is discarded and not transferred to the output unit 108.

When the STC obtained from the STC unit 103 matches the catch-up time (S911), the catch-up detecting unit 110 judges that the PTS of the broadcast stream has caught up with the STC, and thus sends the catch-up signal to the control unit 109 (S905).

The process ends when the comparison between the PTSx and the catch-up time, performed by catch-up detecting unit 110 (S908), shows that the PTSx is not greater than the catch-up time (No in S908).

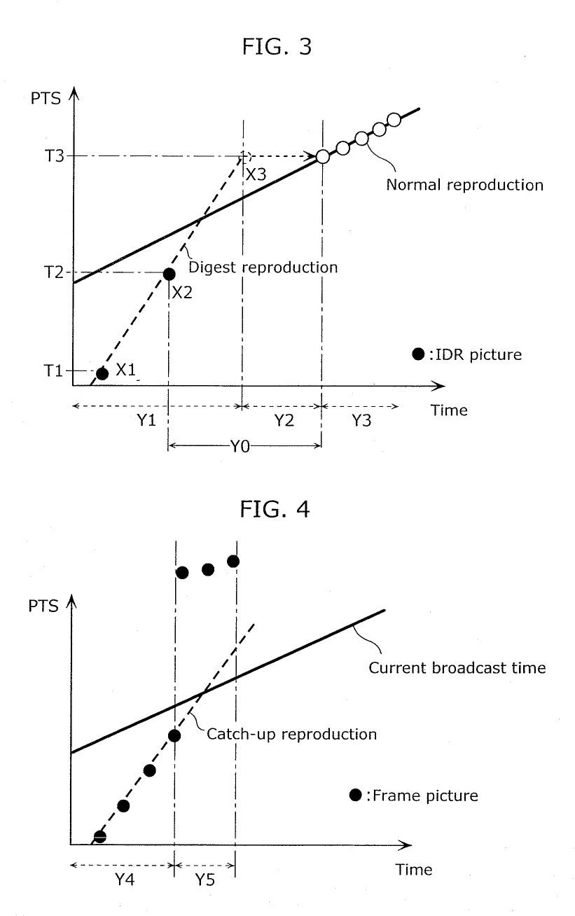

With the above described operations for the catch-up detection in the digest reproduction, the time lag that arises in switching from the digest reproduction to the normal reproduction corresponds to Z0 in the graph of FIG. 12, extending from the digest reproduction of the IDR picture a until the normal reproduction of the picture having a PTS which is equivalent to the catch-up time. In contrast, referring to the graph of FIG. 3, the time lag in the detection method of the prior art corresponds to Y0 extending from the digest reproduction of the IDR picture X2 until the normal reproduction of the picture having a PTS that indicates T3. This shows that the detection method of the present embodiment significantly reduces the time lag that arises in switching between the reproduction modes.

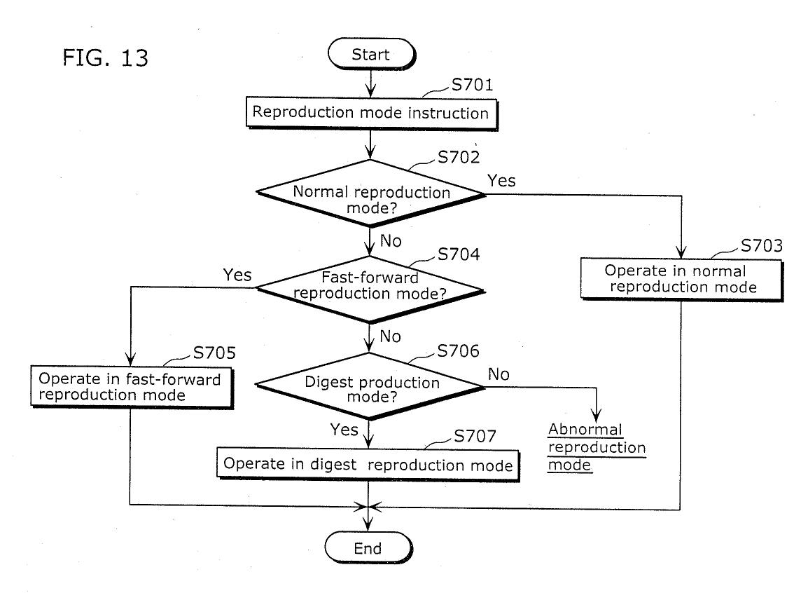

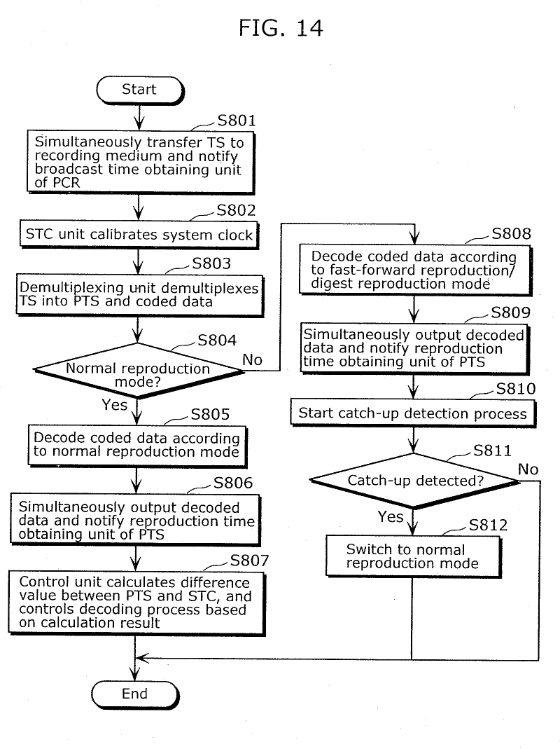

FIGS. 13 and 14 are flow charts showing the operation procedures for the catch-up reproduction performed by the digital television broadcast recording and reproduction apparatus according to the present Embodiment 1. The processing operations shown in FIG. 13 are followed by the processing operations shown in FIG. 14. Hereinafter, the operations shall be described in detail in accordance with the flow charts of FIGS. 13 and 14.

FIG. 13 is a flow chart for determining a reproduction mode of the digital television broadcast recording and reproduction apparatus.

At first, upon reception of a specification from a user, the reproduction mode instructing unit 111 notifies the control unit 109 of a reproduction mode instruction (S701). As mentioned above, the reproduction modes include three modes, i.e. the normal reproduction mode, the fast-forward reproduction mode, and the digest reproduction mode.

When the notified reproduction mode is the normal reproduction mode (Yes in S702), the control unit 109 operates in the normal reproduction mode (S703). Further, the control unit 109 notifies the decoding unit 106 and the catch-up detecting unit 110 of the reproduction mode.

When the notified reproduction mode is not the normal reproduction mode (No in S702), the control unit 109 judges whether or not it is the fast-forward reproduction mode (S704). When the reproduction mode is the fast-forward reproduction mode, the control unit 109 notifies the decoding unit 106 and the catch-up detecting unit 110 that the selected mode is the fast-forward reproduction mode (S705).

When the notified reproduction mode is not the fast-forward reproduction mode (No in S704), the control unit 109 judges whether or not it is the digest reproduction mode (S706). When the reproduction mode is the digest reproduction mode (Yes in S706), the control unit 109 notifies the decoding unit 106 and the catch-up detecting unit 110 that the selected mode is the digest reproduction mode (S707).

When the notified reproduction mode is not the digest reproduction mode (No in S706), the control unit 109 judges that the specified reproduction mode is other than the normal reproduction mode, the fast-forward reproduction mode and the digest reproduction mode, and thus judges the reproduction mode as abnormal. When it is judged as abnormal, a process, such as rebooting the apparatus, is performed.

FIG. 14 is a flow chart schematically showing the operations performed in the reproduction mode determined by the selection procedure shown in FIG. 13.

At first, the tuner 101 simultaneously transfers a TS to the recording medium 104 and notifies the broadcast time obtaining unit 102 of a PCR attached to the TS (S801).

Next, as described above with reference to FIG. 8, the STC unit 103 calibrates the STC with the PCR notified by the broadcast time obtaining unit 102 as an initial value (S802).

Next, the TS transferred to the recording medium 104 is sent to the demultiplexing unit 105. The demultiplexing unit 105 demultiplexes received TS data 201 into a PTS and coded data for vide and audio separately, and transfers the PTS and the coded data to the decoding unit 106 (S803).

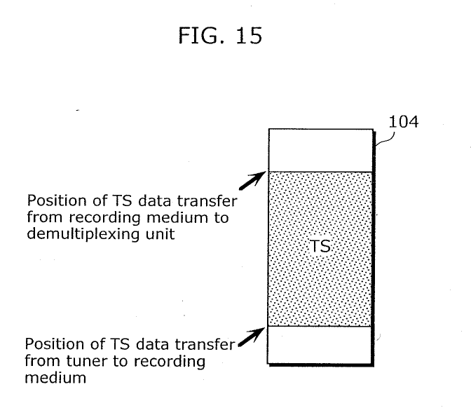

Here, with reference to FIG. 15, the data structure of the recording medium 104 shall be described. The figure shows a state in which the TS data 201 has been written to the recording medium 104. The recording medium 104 manages the position of data transfer from the tuner 101 to the recording medium 104, and the position of data transfer from the recording medium 104 to the demultiplexing unit 105. In the normal reproduction mode, the position of the data transfer from the tuner 101 to the recording medium 104 matches the position of the data transfer from the recording medium 104 to the demultiplexing unit 105. In other words, the recording medium 104 is empty.

On the other hand, in the chasing reproduction mode or the catch-up reproduction mode such as the fast-forward reproduction mode and the digest reproduction mode, the position of the data transfer from the tuner 101 to the recording medium 104 is below the position of the data transfer from the recording medium 104 to the demultiplexing unit 105. In other words, the TS data 201 is stored in the recording medium 104.

FIG. 14 is now referred to again to describe the operations in each of the reproduction modes.

In FIG. 14, when the reproduction mode is the normal reproduction mode (Yes in S804), the decoding unit 106 decodes the coded data according to the normal reproduction mode (S805).

Next, the decoding unit 106 simultaneously transfers the decoded data to the output unit 108 and notifies the reproduction time obtaining unit 107 of a PTS associated with the decoded data (S806).

Next, the control unit 109 obtains the PTS from the reproduction time obtaining unit 107, and the STC from the STC unit, and performs control so that the difference value between the PTS and the STC is within a threshold range, as described above (S807).

When the reproduction mode is not the normal reproduction mode in S804, that is, when it is the fast-forward reproduction mode or the digest reproduction mode (No in S804), the decoding unit 106 decodes the coded data according to the catch-up reproduction mode as described above (S808).

Next, the decoding unit 106 simultaneously transfers the decoded data to the output unit 108 and notifies the reproduction time obtaining unit 107 of a PTS associated with the decoded data (S809).

Next, the catch-up detecting unit 110 obtains the PTS from the reproduction time obtaining unit 107 and the STC from the STC unit 103, and performs the catch-up detection process as described with reference to the flow chart of FIG. 11 (S810).

Next, if the catch-up is detected (Yes in S811), the control unit 109 instructs the decoding unit 106 to switch the reproduction mode from the catch-up reproduction mode to the normal reproduction mode (S812). The decoding unit 106 starts the decoding process according to the normal reproduction mode.

If the catch-up is not detected in S811, the process ends to start the same process for the next TS.

As described above, according to the digital television broadcast recording and reproduction apparatus of Embodiment 1 of the present invention, the catch-up reproduction is performed in accordance with the reproduction mode (the normal reproduction mode, the fast-forward reproduction mode, or the digest reproduction mode). When the digest reproduction is selected as the catch-up reproduction, a catch-up time is predicted, and pictures are sent out from the point of time when the PTS catches up with the STC. As a result, it is possible to eliminate the unnaturalness in output data that arises at the time of switching between the reproduction modes, and to minimize a time lag that arises at the switching process.

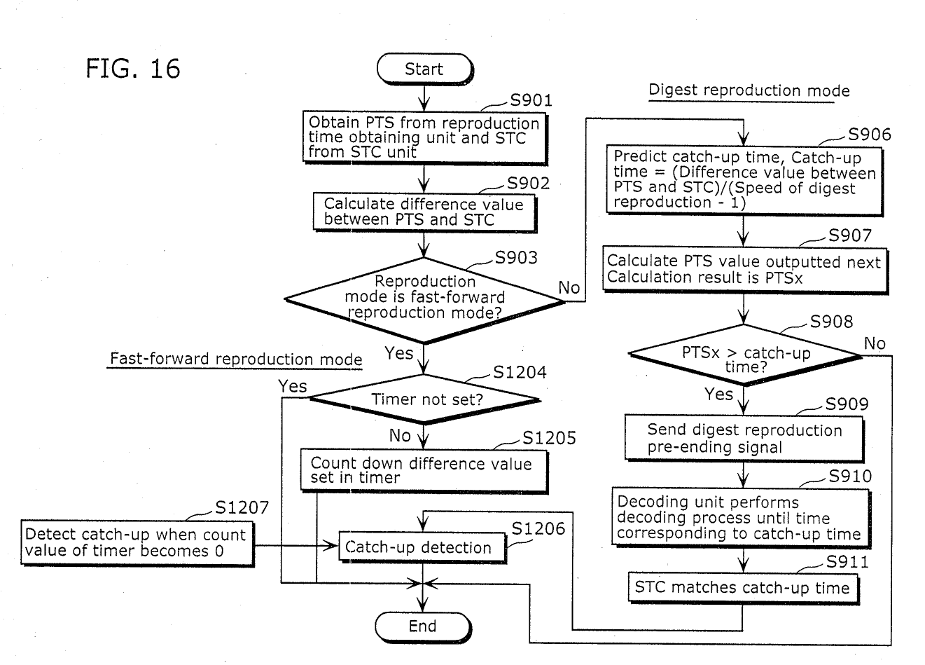

FIG. 16 is a flow chart of operation procedures showing Variation 1 of Embodiment 1 of the present invention. In the flow chart shown in the figure, the following operations and flow are the same as that in the flow chart of the operation procedures shown in FIG. 11: the operation for obtaining a PTS and the STC from the reproduction time obtaining unit (S901); the operation for calculating a difference value between the PTS and the STC (S902); the operation for judging whether or not the reproduction mode is the fast-forward reproduction mode (S903); and the flow for the digest mode reproduction (S906, S907, S908, S909, S910, and S911). When the reproduction mode is the fast-forward reproduction mode, the catch-up detecting unit 110 performs a process that is different from that in the flow chart of FIG. 11.

The description of the same aspects shall be omitted, and different aspects of the operation procedures in the fast-forward reproduction mode shall be described below.

When the fast-forward reproduction mode is selected as the reproduction mode (Yes in S903), the catch-up detecting unit 110 judges whether or not a time counter provided in the catch-up detecting unit 110 is in operation (S1204). When the time counter is not in operation (No in S1204), the catch-up detecting unit 110 sets the time counter with the difference value between the PTS and the STC (S1206). After the timer is set, the process ends. The time counter monotonically decreases its value. When the counter value becomes zero, the time counter sends a timer completion signal to the catch-up detecting unit 110 (S1207). Upon reception of the timer completion signal from the time counter, the catch-up detecting unit 110 judges that the reproduction time of the stream has caught up with the current broadcast time (Step S1206).

When the time counter had already been set in S1204, the process ends.

It is to be noted that when the value of the fast-forward speed is changed during the operation process in the fast-forward reproduction mode, the time counter which is in operation is stopped so that the difference value between the PTS and the STC is calculated again and that the time counter is re-set.

As described above, according to the present variation of the present invention, setting the time counter with the difference value between the time indicated by the PTS of the picture at the start of the fast-forward reproduction and the current broadcast time allows the catch-up detection to be omitted thereafter. As a result, the power consumed by the apparatus can be reduced. In addition, there is no false detection resulting from the abnormality signal generated during the catch-up reproduction, and thus the switch to the normal reproduction can be reliably achieved.

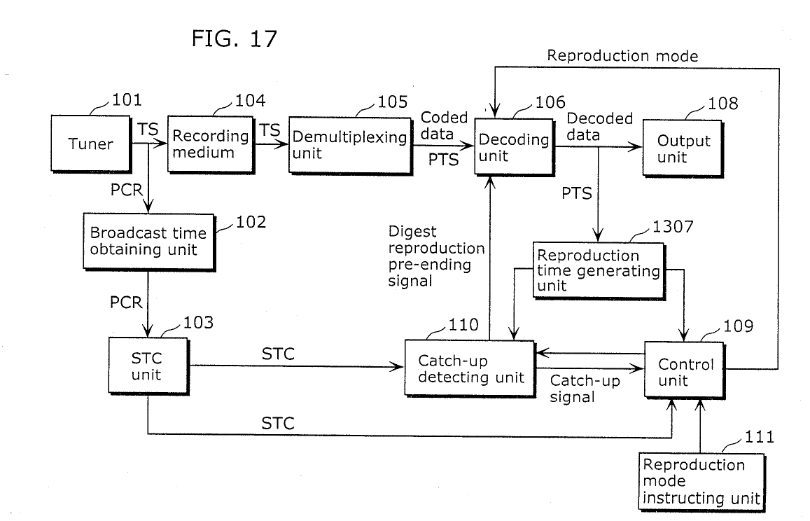

FIG. 17 is a diagram showing the functional configuration of a digital television broadcast recording and reproduction apparatus according to Variation 2 of Embodiment 1 of the present invention. The digital television broadcast recording and reproduction apparatus in the figure includes the tuner 101, the broadcast time obtaining unit 102, the STC unit 103, the recording medium 104, the demultiplexing unit 105, the decoding unit 106, the output unit 108, the control unit 109, the catch-up detecting unit 110, the reproduction mode instructing unit 111, and a reproduction time generating unit 1307. The functional configuration of the figure is different from that of FIG. 5 in that the reproduction time generating unit 1307 is added to replace the reproduction time obtaining unit 107. The description of the same aspects shall be omitted, and different aspects shall be described below.

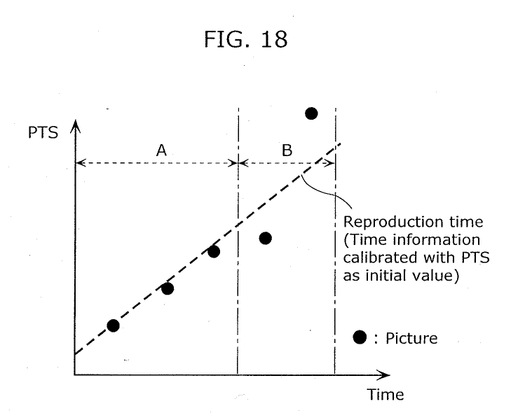

The reproduction time generating unit 1307 calibrates the reproduction time using a PTS notified by the decoding unit 106 as an initial value, and a count frequency of 27 MHz, for example. This count frequency is changeable in accordance with the reproduction speed. For example, when the reproduction speed is double the normal speed, the count frequency is 54 MHz. The reproduction time is calibrated based on the count frequency and the PTS. The method for calibration shall be described with reference to FIG. 18. In the graph of FIG. 18, the horizontal axis represents real time, and the vertical axis represents time indicated by PTS which is reproduction time information, as in FIGS. 8 and 12. An area A in the graph of the figure shows an example where the reproduction time is linearly calibrated with each of values of PTS's notified by the decoding unit 106 as an initial value. In contrast, in an area B of the figure, the calibrated reproduction time is remarkably apart from a PTS that is newly obtained from the decoding unit 106, and thus the reproduction time is not calibrated with the newly obtained PTS as an initial value. In other words, the reproduction time is determined through calibration based on the count frequency and the previously obtained PTS's (the PTS's in the area A of FIG. 18).

In the flow chart of the catch-up detection process shown in FIG. 11, the catch-up detecting unit 110 always obtains a PTS from the reproduction time obtaining unit 107 (S901). However, in the present embodiment, the catch-up detecting unit 110 is notified of the reproduction time which is determined and generated by the reproduction time generating unit 1307.

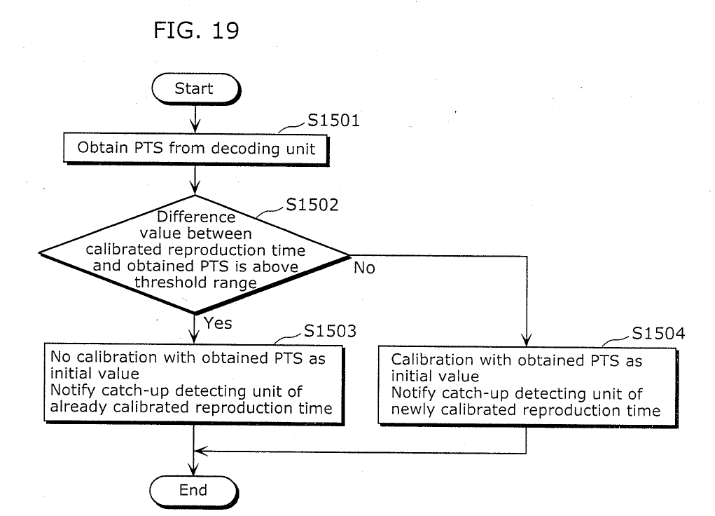

FIG. 19 is a flow chart showing operations of the reproduction time generating unit 1307.

At first, the reproduction time generating unit 1307 obtains a new PTS from the decoding unit 106 (S1501). Next, when the difference value between the reproduction time already calibrated and held, and the newly obtained PTS is above a predetermined threshold range (Yes in S1502), the reproduction time generating unit 1307 does not calibrate the reproduction time with the newly obtained PTS as an initial value, but notifies the catch-up detecting unit 110 and the control unit 109 of the reproduction time already calibrated and held, as a newly calibrated reproduction time (S1503). When the difference value between the reproduction time already calibrated and held and the newly obtained PTS is within the predetermined threshold range (No in S1502), the reproduction time generating unit 1307 calibrates the reproduction time with the newly obtained PTS as an initial value, and notifies the catch-up detecting unit 110 and the control unit 109 of the calibrated reproduction time (S1504). The catch-up detecting unit 110 performs the catch-up detection process using the obtained reproduction time.

As described above, according to Variation 2 of Embodiment 1 of the present invention, even in a situation where it was not possible to correctly obtain a PTS, providing a function for generating reproduction time information based on the received PTS value prevents an unnecessary waiting time attributed to such a situation, and thus, the catch-up can be detected with accuracy.

### Embodiment 2

Next, Embodiment 2 according to the present invention shall be described.

A digital television broadcast recording and reproduction apparatus according to Embodiment 2 of the present invention starts the catch-up detection process in the catch-up reproduction when the amount of TS data 201 remaining in the recording medium 104 reaches zero. Therefore, there is no need to perform the catch-up detection on a picture-by-picture basis from the beginning of the chasing reproduction. As a result, the workload for the catch-up detection is reduced, enabling reduction of power consumption.

Hereinafter, with reference to the drawings, Embodiment 2 of the present invention shall be described in detail.

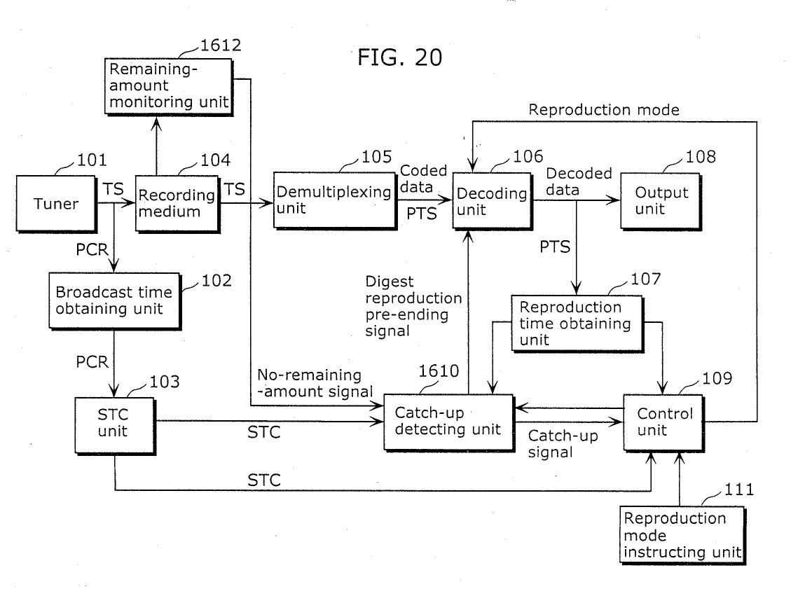

FIG. 20 is a diagram showing the functional configuration of the digital television broadcast recording and reproduction apparatus according to Embodiment 2 of the present invention.

The digital television broadcast recording and reproduction apparatus in the figure includes the tuner 101, the broadcast time obtaining unit 102, the STC unit 103, the recording medium 104, the demultiplexing unit 105, the decoding unit 106, the reproduction time obtaining unit 107, the output unit 108, the control unit 109, the reproduction mode instructing unit 111, a catch-up detecting unit 1610, and a remaining-amount monitoring unit 1612.

The functional configuration of the figure is different from that of FIG. 5 in that the remaining-amount monitoring unit 1612 is added, and the catch-up detecting unit 1610 is provided to replace the catch-up detecting unit 110. The description of the same aspects shall be omitted, and different aspects shall be described below.

The remaining-amount monitoring unit 1612 monitors the remaining amount of the TS data 201 recorded in the recording medium 104 in the catch-up reproduction mode (the fast-forward reproduction or the digest reproduction). As described above, FIG. 15 schematically shows the structure of the recording medium 104. In the figure, when the position of the data transfer from the tuner 101 to the recording medium 104 matches the position of the data transfer from the recording medium 104 to the demultiplexing unit 105, the remaining-amount monitoring unit 1612 sends a no-remaining-amount signal to the catch-up detecting unit 1610. Here, the coded data and a PTS of the coded data is accumulated in a buffer of the demultiplexing unit 105. Therefore, there are still pictures in the buffer before the current broadcast is reached.

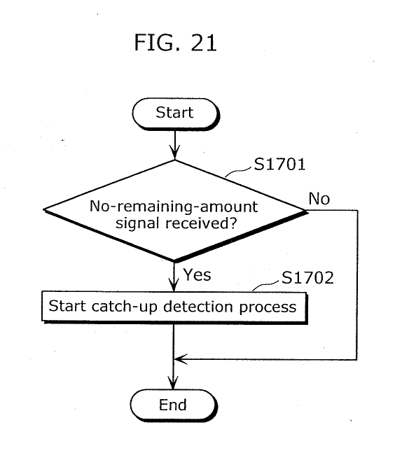

FIG. 14 and FIG. 21 are flow charts showing the operations of the digital television broadcast recording and reproduction apparatus according to the present Embodiment 2. Hereinafter, the operations shall be described in detail in accordance with the flow charts of FIGS. 14 and 21.

FIG. 14 is a flow chart schematically showing the operations in the normal reproduction mode, the fast-forward reproduction mode, and the digest reproduction mode. The process operation in each step is the same as that in Embodiment 1, but the timing to start the catch-up detection process (S810) is different from that in Embodiment 1. The description of the same aspects shall be omitted, and different aspects shall be described below.

The catch-up detecting unit 1610 shown in FIG. 20 starts the catch-up detection process (S810) when it receives the no-remaining-amount signal from the remaining-amount monitoring unit 1612. With reference to the flow chart of FIG. 21, the operation for starting the catch-up detection process shall be described.

When the catch-up detecting unit 1610 receives the no-remaining-amount signal sent from the remaining-amount monitoring unit 1612 (Yes in S1701), it starts the catch-up detection process (S1702).

In the case where the no-remaining-amount signal is not received from the remaining-amount monitoring unit 1612 (No in S1701), the catch-up detecting unit 1610 does not start the catch-up detection process but ends the process, and waits for the no-remaining-amount signal.

As described above, according to the digital television broadcast recording and reproduction apparatus of Embodiment 2 of the present invention, the catch-up detection process starts when the amount of data remaining in the recording medium 104 becomes zero, so that the picture-by-picture based catch-up detection process which starts from the beginning of the catch-up reproduction can be omitted. Consequently, the workload for the catch-up detection is reduced, which results in reduction of the power consumed by the apparatus.

### Embodiment 3

Next, Embodiment 3 according to the present invention shall be described.

A digital television broadcast recording and reproduction apparatus according to Embodiment 3 of the present invention forcibly stops the catch-up detection process in the catch-up reproduction and switches the reproduction mode to the normal reproduction when the amount of data remaining in the recording medium 104 is zero and the decoding process is abnormal. As a result, false detection in the catch-up detection process is prevented, and thus it is possible to prevent output data from being frozen and to prevent the normal reproduction from starting at an unexpected scene. Thus, an unnecessary waiting time does not occur, and the catch-up detection can be performed with accuracy.

Hereinafter, with reference to the drawings, Embodiment 3 of the present invention shall be described in detail.

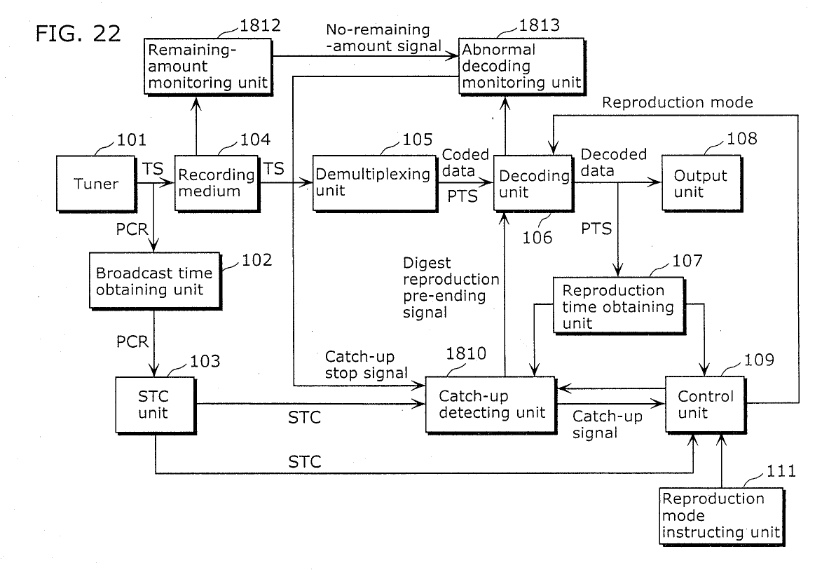

FIG. 22 is a diagram showing the functional configuration of the digital television broadcast recording and reproduction apparatus according to Embodiment 3.

The digital television broadcast recording and reproduction apparatus in the figure includes the tuner 101, the broadcast time obtaining unit 102, the STC unit 103, the recording medium 104, the demultiplexing unit 105, the decoding unit 106, the reproduction time obtaining unit 107, the output unit 108, the control unit 109, the reproduction mode instructing unit 111, a remaining-amount monitoring unit 1812, a catch-up detecting unit 1810, and an abnormal-decoding monitoring unit 1813.

The functional configuration of the figure is different from that of FIG. 5 in that the remaining-amount monitoring unit 1812 and the abnormal-decoding monitoring unit 1813 are added, and the catch-up detecting unit 1810 is provided to replace the catch-up detecting unit 110.

The description of the same aspects shall be omitted, and different aspects shall be described below.

The remaining-amount monitoring unit 1812 monitors the remaining amount of the TS data 201 recorded in the recording medium 104 in the catch-up reproduction mode (the fast-forward reproduction or the digest reproduction). As described above, FIG. 15 schematically shows the structure of the recording medium 104. In the figure, when the position of the data transfer from the tuner 101 to the recording medium 104 matches the position of the data transfer from the recording medium 104 to the demultiplexing unit 105, the remaining-amount monitoring unit 1812 sends the no-remaining-amount signal to the catch-up detecting unit 1810. Here, the coded data and a PTS of the coded data are accumulated in the buffer of the demultiplexing unit 105. Therefore, there are still pictures in the buffer before the current broadcast is reached. The abnormal-decoding monitoring unit 1813 monitors the status of the decoding process of the decoding unit 106, and detects that the decoding process has become abnormal when a bit error occurs, for example. The abnormal decoding process here is, for example, a syntax error in the case of video, and abnormality in a parameter of an ADTS (Audio Data Transport Stream) in the case of audio. When the abnormal-decoding monitoring unit 1813 receives the no-remaining-amount signal from the remaining-amount monitoring unit 1812, and detects an abnormal decoding process of the decoding unit 106 as described above, it sends a catch-up stop signal to the catch-up detecting unit 1810.

Upon reception of the catch-up stop signal, the catch-up detecting unit 1810 stops the catch-up detection process and sends a catch-up signal to the control unit 109. Upon-reception of the catch-up signal, the control unit 109 switches the reproduction mode from the catch-up reproduction mode (the fast-forward reproduction or the digest reproduction) to the normal reproduction mode.

As described above, according to the digital television broadcast recording and reproduction apparatus of Embodiment 3 of the present invention, when the amount of data remaining in the recording medium 104 is zero and the decoding process is abnormal, the catch-up detection process is forcibly stopped and the production mode is switched to the normal reproduction mode. As a result, false detection in the catch-up detection process can be prevented, which makes it possible to prevent output data from being frozen and prevent the normal reproduction from starting at an unexpected scene, and thus, an unnecessary waiting time can be prevented, and the catch-up can be detected with accuracy. In addition, the power consumption can be reduced.

It is to be noted, as described above, that there are pictures, up to the current broadcast, stored in the buffer of the demultiplexing unit 105, and these pictures are discarded. Nonetheless, from the viewpoint of fail-safe design, rather than falsely detecting a catch-up time with a picture judged as being abnormal in the decoding process, it is preferred to stop the catch-up detection and switch to the current broadcast.

### Embodiment 4

Next, Embodiment 4 according to the present invention shall be described.

Embodiment 4 of the present invention shows a case where the digital television broadcast recording and reproduction apparatus according to the present invention is used for a mobile phone.

Hereinafter, with reference to the drawings, Embodiment 4 of the present invention shall be described in detail.

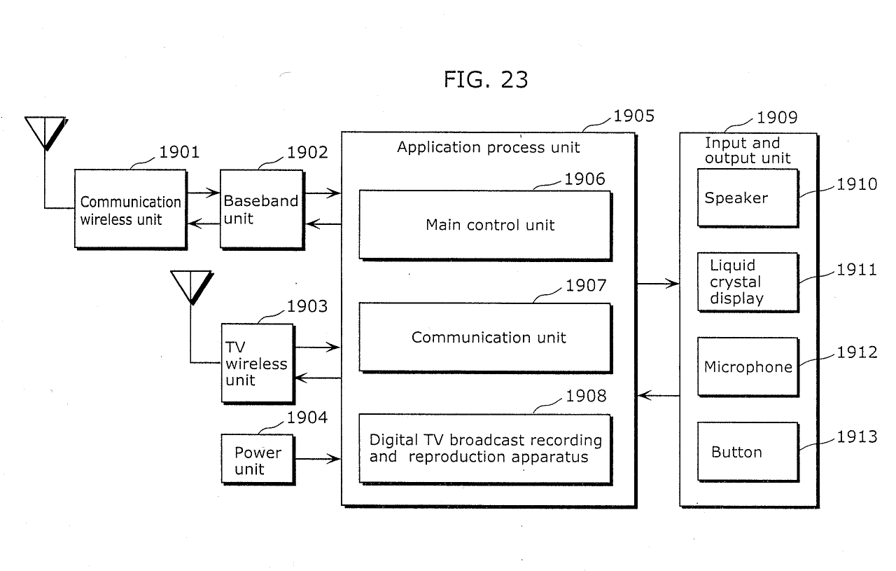

FIG. 23 is a block diagram showing the entire configuration in the case where the present invention is applied to a mobile phone as an embodiment of the digital television broadcast recording and reproduction apparatus according to the present invention. The mobile phone in Embodiment 4 includes a communication wireless unit 1901, a baseband unit 1902, a TV wireless unit 1903 for receiving digital television broadcast signals, a power unit 1904, an application process unit 1905 which performs various control, and an input and output unit 1909.

The application process unit 1905 includes a main control unit 1906 which controls the entire mobile phone, a communication unit 1907 which controls communication, and a digital TV broadcast recording and reproduction apparatus 1908.

The input and output unit 1909 includes a speaker 1910 which outputs audio, a liquid crystal display 1911 which outputs video, a microphone 1912 which receives audio, and a button 1913 for key operations.

With reference to FIG. 23, the following shall describe the function of the digital television broadcast recording and reproduction apparatus of the present invention in the normal reproduction and the catch-up reproduction.

A digital television broadcast signal is received by an antenna, and is sent to the application process unit 1905 via the TV wireless unit 1903. The application process unit 1905 sends the received digital television broadcast signal to the digital TV broadcast recording and reproduction apparatus 1908. The digital TV broadcast recording and reproduction apparatus 1908 decodes the digital television broadcast signal and sends a video signal and an audio signal to the input and output unit 1909. Then, the video signal is outputted by the liquid crystal display 1911, and the audio signal by the speaker 1910. The switch between the normal reproduction and the catch-up reproduction is carried out using the button 1913.

As described above, according to the digital television broadcast recording and reproduction apparatus of the present invention, (1) in the digest reproduction, a catch-up time is predicted, and pictures start to be outputted when a PTS catches up with the STC, (2) in the digest reproduction or the fast-forward reproduction, the catch-up detection process starts when the amount of data remaining in the recording medium becomes zero, and (3) in digest reproduction or the fast-forward reproduction, the catch-up detection process is forcibly stopped and the reproduction is switched to the normal reproduction when the amount of data remaining in the recording medium is zero and the decoding process is abnormal. As a result, it is possible to: eliminate the unnaturalness in output data that arises when switching between the reproduction modes; and prevent the output data from being frozen; prevent the normal reproduction from starting at an unexpected scene, and thus no unnecessary waiting time arises, and the time lag in switching from the catch-up reproduction to the normal reproduction is minimized. In addition, the power consumption can be reduced.

The digital television broadcast recording and reproduction apparatus of the present invention has been described based on some embodiments. However, the present invention is not to be limited by such embodiments. Those skilled in the art will readily appreciate that many modifications are possible in such embodiments without materially departing from the novel teachings and advantages of the present invention. Accordingly, all such modifications are intended to be included within the scope of the present invention.

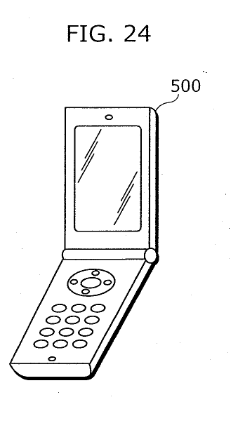

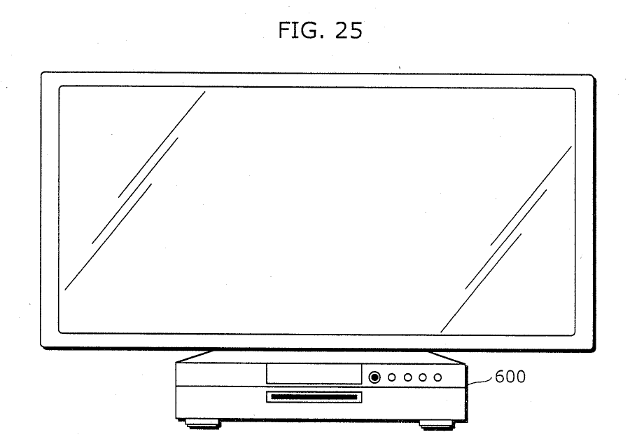

In addition, an exemplary embodiment here has shown a mobile phone in which the digital television broadcast recording and reproduction apparatus of the present invention is used, but the digital television broadcast recording and reproduction apparatus can be also used for other appliances which can reproduce video and audio. For example, FIG. 24 is an external view of a mobile phone 500 in which the digital television broadcast recording and reproduction apparatus of the present invention is used, and FIG. 25 is an external view of a DVD player 600 in which the digital television broadcast recording and reproduction apparatus of the present invention is used.

### INDUSTRIAL APPLICABILITY

The present invention can be applied to digital television broadcast recording and reproduction apparatuses, and especially to apparatuses which simultaneously perform recording and reproduction with a chasing reproduction function, and so on.

What is claimed is:

1. A digital television broadcast recording and reproduction apparatus which has a readable and writable recording medium, and records and reproduces information of a digital television signal received, said apparatus comprising:
a control unit configured to receive an instruction from a user concerning either normal reproduction or digest reproduction, and manage the received instruction, the normal reproduction being for real-time reproduction of the digital television signal, and the digest reproduction being for partial reproduction of the digital television signal recorded in the recording medium;
a decoding unit configured to (i) in the normal reproduction, decode all pictures of coded data included in the digital television signal, and output the decoded data and time stamps each of which is associated with corresponding one of the decoded pictures, and (ii) in the digest reproduction, decode the pictures of the coded data at regular intervals, and output the decoded data and time stamps each of which is associated with corresponding one of the decoded pictures; and
a catch-up detecting unit configured to perform a digest catch-up detection process of (i) calculating, for each of the time stamps outputted in the digest reproduction, a difference value between a time indicated by the time stamp and a time of a current broadcast, (ii) calculating, based on the calculated difference value, a catch-up time at which the digest reproduction catches up with the current broadcast, (iii) sending a digest reproduction pre-ending signal to said decoding unit when judging, based on the calculated catch-up time, that a time indicated by a time stamp of a next picture overtakes the catch-up time, and (iv) sending a catch-up signal to said control unit when the catch-up time matches the time of the current broadcast,
wherein said decoding unit is configured to end the decoding for the digest reproduction when the digest reproduction pre-ending signal is received from said catch-up detecting unit during the digest reproduction, and
said control unit is configured to, when the catch-up signal is received from said catch-up detecting unit, cause said decoding unit to start the normal reproduction by notifying said decoding unit that the digest reproduction is to be switched to the normal reproduction.

2. The digital television broadcast recording and reproduction apparatus according to claim 1, further comprising
a remaining-amount monitoring unit configured to monitor a remaining amount of the digital television signal accumulated in the recording medium, and when the remaining amount becomes zero, send a no-remaining-amount signal to said catch-up detecting unit indicating that the remaining amount has become zero,
wherein said control unit is configured to receive an instruction from the user concerning fast-forward reproduction for fast-forwarding the digital television signal, and manage the received instruction,
said decoding unit is configured to, in the fast-forward reproduction, decode all the pictures of the coded data included in the digital television signal, and output the decoded data and time stamps each of which is associated with corresponding one of the decoded pictures,
said catch-up detecting unit is further configured to, in the fast-forward reproduction, perform a fast-forward catch-up detection process of sending the catch-up signal to said control unit when the fast-forward reproduction catches up with the current broadcast, and
said catch-up detecting unit is configured to start either the fast-forward catch-up detection process or the digest catch-up detection process when the no-remaining-amount signal is received from said remaining-amount monitoring unit.

3. The digital television broadcast recording and reproduction apparatus according to claim 1, further comprising:
an abnormal-decoding monitoring unit configured to detect abnormal decoding performed by said decoding unit; and
a remaining-amount monitoring unit configured to monitor a remaining amount of the digital television signal accumulated in the recording medium, and when the remaining amount becomes zero, send a no-remaining-amount signal to said abnormal-decoding monitoring unit indicating that the remaining amount has become zero,
wherein said control unit is configured to receive an instruction from the user concerning fast-forward reproduction for fast-forwarding the digital television signal, and manage the received instruction,
said decoding unit is configured to, in the fast-forward reproduction, decode all the pictures of the coded data included in the digital television signal, and output the decoded data and time stamps each of which is associated with corresponding one of the decoded pictures,
said catch-up detecting unit is configured to, in the fast-forward reproduction, perform a fast-forward catch-up detection process of sending the catch-up signal to said control unit when the fast-forward reproduction catches up with the current broadcast,
said abnormal-decoding monitoring unit is configured to send a catch-up stop signal to said catch-up detecting unit when the no-remaining-amount signal is received from said remaining-amount monitoring unit and the abnormal decoding is detected, and
said catch-up detecting unit is configured to stop either the fast-forward catch-up detection process or the digest catch-up detection process when the catch-up stop signal is received.

4. The digital television broadcast recording and reproduction apparatus according to claim 1,
wherein said control unit is configured to receive an instruction from the user concerning fast-forward reproduction for fast-forwarding the digital television signal, and manage the received instruction,
said decoding unit is configured to, in the fast-forward reproduction, decode all the pictures of the coded data included in the digital television signal, and output the decoded data and time stamps each of which is associated with corresponding one of the decoded pictures, and
said catch-up detecting unit (i) includes a time counter that monotonically decreases a count value as time elapses, and (ii) is configured to initialize, at a start of the fast-forward reproduction, said time counter with a difference value between a time indicated by one of the time stamps outputted in the fast-forward reproduction and the time of the current broadcast, and to send the catch-up signal to said control unit when the count value becomes zero.

5. The digital television broadcast recording and reproduction apparatus according to claim 1, further comprising,
a reproduction time generating unit configured to (i) withhold outputting of a time stamp of a most recent picture to said catch-up detecting unit, (ii) generate a time stamp to replace the time stamp of the most recent picture based on time stamps of preceding pictures up to a picture immediately preceding the most recent picture and (iii) output the generated time stamp to said catch-up detecting unit, when a difference value between the time indicated by the time stamp of the most recent picture obtained from said decoding unit and a time indicated by the time stamp of the picture immediately preceding the most recent picture is above a predetermined threshold range.

6. A mobile phone comprising the digital television broadcast recording and reproduction apparatus according to claim 1.

7. A reproduction method for a digital television broadcast recording and reproduction apparatus which has a readable and writable recording medium, and records and reproduces information of a digital television signal received, said method comprising:
receiving an instruction from a user concerning either normal reproduction or digest reproduction, and managing the received instruction, the normal reproduction being for real-time reproduction of the digital television signal, and the digest reproduction being for partial reproduction of the digital television signal recorded in the recording medium;
decoding the pictures of the coded data at regular intervals to output the decoded data and time stamps each of which is associated with corresponding one of the decoded pictures, when the instruction received in said receiving is concerning the digest reproduction;
calculating, for each of the time stamps outputted in said decoding, a difference value between a time indicated by the time stamp and a time of a current broadcast;
calculating, based on the difference value, a catch-up time at which the digest reproduction catches up with the current broadcast;
judging, based on the catch-up time, whether or not a time indicated by a time stamp of a next picture overtakes the catch-up time;
ending said decoding for the digest reproduction when it is judged in said judging that the time indicated by the time stamp overtakes the catch-up time;
judging whether or not the catch-up time matches the time of the current broadcast; and
ending the digest reproduction by switching from the digest reproduction to the normal reproduction, when it is judged in said judging that the catch-up time matches the time of the current broadcast.

8. A digital television broadcast recording and reproduction apparatus, comprising:
a control unit configured to receive an instruction from a user concerning digest reproduction for partial reproduction of a digital television signal recorded in a recording medium;
a decoding unit configured to, in the digest reproduction, decode pictures of coded data at regular intervals; and
a switching unit configured to predict a catch-up time based on a reproduction time in the digest reproduction and a current broadcast time, and to switch from the digest reproduction to normal reproduction at the predicted catch-up time.
